(19) United States
(12) Patent Application Publication
(10) Pub. No.: US 2012/0142880 A1
(43) Pub. Date: Jun. 7, 2012

(54) LITHIUM SECONDARY BATTERY

(76) Inventors: Norio Iwayasu, Hitachinaka (JP); Jinbao Zhao, Xiamen (CN); Hidetoshi Honbo, Hitachinaka (JP)

(21) Appl. No.: 13/313,041

(22) Filed: Dec. 7, 2011

(30) Foreign Application Priority Data
Dec. 7, 2010 (JP) 2010-272122

(51) Int. Cl. H01M 10/42; C08F 12/18; C08F 14/06; C08F 20/24; H01M 10/056; C08F 12/16

(52) U.S. Cl. 526/292.6; 526/293; 526/309

(57) ABSTRACT

In a lithium secondary battery, an overcharge inhibitor is used which includes polymerizable compounds or a polymer, or both as an active component, the polymerizable compounds including a first polymerizable compound having an aromatic functional group and a polymerizable functional group, and a second polymerizable compound having a halogen-containing functional group and a polymerizable functional group, and the polymer including a polymer having the halogen-containing functional group, the aromatic functional group, and residues of the polymerizable functional groups. The present invention allows the lithium secondary battery to form a radical-trapping polymer layer on the cathode upon overcharge.

### CLAIM OF PRIORITY

The present application claims priority from Japanese Patent application serial No. 2010-272122, filed on Dec. 7, 2010, the content of which is hereby incorporated by reference into this application.

### BACKGROUND OF THE INVENTION

1. Field of the Invention

The present invention relates to a lithium secondary battery.

2. Description of Related Art

Since lithium secondary batteries have a high energy density, they are widely used in notebook computers and cellular phones, taking full advantage of this property. Independently, the lithium secondary batteries are also intended to be adopted as power sources to electric vehicles, because the electric vehicles have recently drawn increasing attention from the viewpoint of the prevention of a global warming due to increasing carbon dioxide.

Although having satisfactory properties as above, the lithium secondary batteries have some challenges. One of them is improvement of safety. Above all, the insurance of safety upon overcharge is an important challenge.

If a lithium secondary battery is overcharged, the battery may have insufficient thermal stability and thereby have inferior safety. To avoid this, current lithium secondary batteries ensure satisfactory safety by being provided with a control circuit that detects a state of overcharge to stop charging. The detection of the state of the overcharge is performed by monitoring a battery voltage. However, there is a small difference between a battery operating voltage and a voltage in the state of the overcharge, and this impedes appropriate detection of the overcharge by the control circuit. In addition, if the control circuit goes out of order, the overcharge may occur. For these reasons, it is important to ensure the safety of a lithium secondary battery itself upon the overcharge.

Japanese Patent Application Laid-Open No. 2006-054167 (Document 1) discloses a technique of adding a polymeric compound including a bromine-containing aromatic functional group to a battery so as to suppress a gas generated during high-temperature storage of the battery.

Japanese Patent Application Laid-Open No. 2001-185213 (Document 2) discloses a technique of adding a halogen-containing aromatic compound to a battery to improve low-temperature properties of the battery.

### SUMMARY OF THE INVENTION

The present invention provides a lithium secondary battery which includes polymerizable compounds or a polymer, or both in an aspect. The polymerizable compounds include a first polymerizable compound having an aromatic functional group and a polymerizable functional group, and a second polymerizable compound having a halogen-containing functional group and a polymerizable functional group. The polymer includes the halogen-containing functional group, the aromatic functional group and residues of the polymerizable functional groups.

The present invention allows the battery to have higher safety upon overcharge without deteriorating a battery performance.

### BRIEF DESCRIPTION OF THE DRAWINGS

FIG. 1 is a local sectional view illustrating a lithium secondary battery (a cylindrical lithium-ion battery) according to an embodiment.

FIG. 2 is a cross-sectional view illustrating a lithium secondary battery (a laminated lithium-ion battery) according to another embodiment.

FIG. 3 is a perspective view illustrating a lithium secondary battery (a rectangular lithium-ion battery) according to yet another embodiment.

FIG. 4 is a cross-sectional view taken along line A-A in FIG. 3.

### DETAILED DESCRIPTION OF THE PREFERRED EMBODIMENTS

When the compounds described in Document 1 and Document 2 are added thereto, the batteries tend to have inferior battery properties. The addition of these compounds effectively improves the thermal stability of a cathode upon overcharge, but adversely affects the thermal stability of an anode. For these reasons, it is difficult to ensure the battery safety upon the overcharge even according to these techniques.

Accordingly, an object of the present invention is to ensure the battery safety upon the overcharge by using a substance that reacts upon the overcharge to form a radical-trapping polymer layer on the cathode.

After intensive investigations, we have found an overcharge inhibitor that reacts at an increased cathode potential upon the overcharge to form the polymer layer containing a halogen having a radical trapping activity on the cathode. The overcharge inhibitor has high electrochemical stability within operating voltages of the battery and can be used without adversely affecting the battery performance.

Hereinafter, a lithium secondary battery according to an embodiment of the present invention, a production method thereof and a method for producing a polymer for use in the lithium secondary battery. The lithium secondary battery is also referred to as a lithium ion secondary battery herein.

The lithium secondary battery contains an electrode group and an electrolytic solution, in which the electrode group includes a cathode, an anode and a separator interposed between the cathode and the anode.

The cathode herein has been formed by applying a cathode material to a current collector; and the anode has been formed by applying an anode material to another current collector.

The lithium secondary battery includes polymerizable compounds or a polymer, or both. The polymerizable compounds include a first polymerizable compound having an aromatic functional group and a polymerizable functional group, and a second polymerizable compound having a halogen-containing functional group and a polymerizable functional group, whereas the polymer includes the halogen-containing functional group, the aromatic functional group and residues of the polymerizable functional groups.

In the lithium secondary battery, the polymerizable compounds may further include a third polymerizable compound having a highly polar functional group and a polymerizable functional group, whereas the polymer may further have the highly polar functional group.

In the lithium secondary battery, the aromatic functional group may have a halogen-containing functional group.

In the lithium secondary battery, the polymerizable compounds may include the first polymerizable compound represented by the following Chemical Formula (1) or (2); and the second and third polymerizable compounds respectively represented by the following Chemical Formulae (3) and (4):

Z¹—X-A Chemical Formula (1)

Z¹-A Chemical Formula (2)

Z²—Y Chemical Formula (3)

Z³—W Chemical Formula (4)

In the Chemical Formulae, Z¹, Z² and Z³ are respectively polymerizable functional groups; X is a hydrocarbon group or an oxyalkylene group having 1 to 20 carbon atoms; A is an aromatic functional group; Y is a halogen-containing functional group; and W is a highly polar functional group.

The lithium secondary battery may include a polymer obtained from the polymerizable compounds through polymerization.

The polymer in the lithium secondary battery may include a polymer represented by the following Chemical Formula (5) or (6):

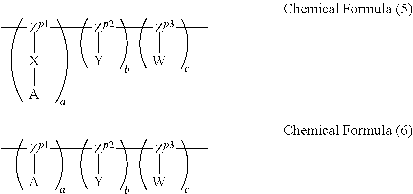

In the Chemical Formulae, Z^{p1}, Z^{p2} and Z^{p3} are respectively residues of polymerizable functional groups; X is a hydrocarbon group or an oxyalkylene group having 1 to 20 carbon atoms; A is an aromatic functional group; Y is a halogen-containing functional group; W is a highly polar functional group; and subscripts “a”, “b” and “c” independently represent ratios on molar basis.

In the lithium secondary battery, the polymer may be represented by the following Chemical Formula (7):

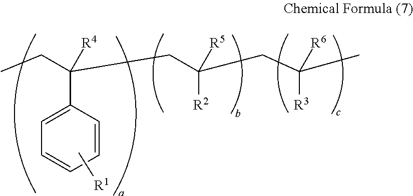

In the Chemical Formula, R¹ is one selected from the group consisting of hydrogen atom, an aliphatic hydrocarbon group, an alicyclic hydrocarbon group and an aromatic group; R² is a halogen-containing functional group; R³ is a functional group having one selected from the group consisting of an oxyalkylene group, cyano group, amino group and hydroxyl group; R⁴, R⁵ and R⁶ are each independently hydrogen atom or a hydrocarbon group; and subscripts “a”, “b” and “c” independently represent ratios on molar basis.

The halogen in the lithium secondary battery is preferably bromine or chlorine.

In the lithium secondary battery, the polymerizable compounds or the polymer, or both may be included in the electrolytic solution.

The polymerizable compounds or the polymer, or both included in the lithium secondary battery serve as an active component of an overcharge inhibitor.

The present invention provides a method for producing a polymer, including the steps of preparing a mixture including a first polymerizable compound and a second polymerizable compound, the first polymerizable compound having an aromatic functional group and a polymerizable functional group, and the second polymerizable compound having a halogen-containing functional group and a polymerizable functional group; and polymerizing the first and second polymerizable compounds in another aspect.

In the method, the mixture may further include a third polymerizable compound having a highly polar functional group and a polymerizable functional group.

In the method, the aromatic functional group preferably has the halogen-containing functional group.

In the method, the mixture may include a first polymerizable compound represented by the above Chemical Formula (1) or (2); a second polymerizable compound represented by the above Chemical Formula (3); and a third polymerizable compound represented by the above Chemical Formula (4).

The method preferably further includes a step of adding a polymerization initiator to the mixture to perform a reaction.

The polymerizable functional group is not limited, as long as one undergoing a polymerization reaction, but is preferably an organic group having an unsaturated double bond such as vinyl group, acryloyl group or methacryloyl group.

Examples of the hydrocarbon group having 1 to 20 carbon atoms include aliphatic hydrocarbon groups such as methylene group, ethylene group, propylene group, isopropylene group, butylene group, isobutylene group, dimethylethylene group, pentylene group, hexylene group, heptylene group, octylene group, isooctylene group, decylene group, undecylene group and dodecylene group; and alicyclic hydrocarbon groups such as cyclohexylene group and dimethylcyclohexylene group.

Exemplary oxyalkylene groups include oxymethylene group, oxyethylene group, oxypropylene group, oxybutylene group and oxytetramethylene group.

The aromatic functional group may be a functional group having 20 or less carbon atoms and satisfying Hückel rule. Specifically, examples of such aromatic functional groups include cyclohexylbenzyl group, biphenyl group and phenyl group, as well as fused derivatives thereof such as naphthyl group, anthryl group, phenanthryl group, triphenylene group, pyrene group, chrysene group, naphthacene group, picene group, perylene group, pentaphene group, pentacene group and acenaphthylene group. Each of such aromatic functional groups may be substituted partially. The aromatic functional group may include another element than carbon in the aromatic ring. The term “element” as used herein includes S, N, Si and O for example. Among the aromatic functional groups, phenyl group, cyclohexylbenzyl group, biphenyl group, naphthyl group, anthracene group and tetracene group are preferred from the viewpoint of electrochemical stability, of which cyclohexylbenzyl group and biphenyl group are particularly preferred.

The selection of a suitable aromatic functional group allows the polymer to form a film or coat on a surface of the cathode upon overcharge to thereby improve the thermal stability of the cathode.

As used herein the term “polymer” refers to a compound obtained from polymerizable compound(s) through polymerization.

In the present invention, polymerizable compounds or a polymer, or both may be used. However, it is preferred to use a polymer after purifying the polymer formed by polymerizing polymerizable compounds in advance. This is preferred from the viewpoint of the electrochemical stability.

The polymerization may be performed through any of customarily known polymerization processes such as bulk polymerization, solution polymerization and emulsion polymerization. Though not limited, the polymerization is preferably performed by a radical polymerization. Upon the polymerization, the polymerization initiator may be used or not. A radical polymerization initiator is preferably used because of its good handleability. A polymerization process using such a radical polymerization initiator may be performed at temperatures for a polymerization time within ranges generally employed.

The Polymerization initiator may be used in an amount of from 0.1 to 20 parts by weight, and preferably from 0.3 to 5 parts by weight per 100 parts by weight of the polymerizable compounds.

Exemplary radical polymerization initiators include organic peroxides such as t-butyl peroxypivalate, t-hexyl peroxypivalate, methyl ethyl ketone peroxide, cyclohexanone peroxide,

1,1-bis(t-butylperoxy)-3,3,5-trimethylcyclohexane, 2,2-bis(t-butylperoxy)octane, n-butyl-4,4-bis(t-butylperoxy)valerate, t-butyl hydroperoxide, cumene hydroperoxide, 2,5-dimethylhexane-2,5-dihydroperoxide, di-t-butyl peroxide, t-butyl cumyl peroxide, dicumyl peroxide, α,α′-bis(t-butylperoxy-m-isopropyl)benzene, 2,5-dimethyl-2,5-di(t-butylperoxy)hexane, 2,5-dimethyl-2,5-di(t-butylperoxy)hexane, benzoyl peroxide, and t-butylperoxypropyl carbonate; and azo compounds such as 2,2′-azobisisobutyronitrile, 2,2′-azobis(2-methylbutyronitrile), 2,2′-azobis(4-methoxy-2,4-dimethylvaleronitrile), 2,2′-azobis(2,4-dimethylvaleronitrile), 1,1′-azobis(cyclohexane-1-carbonitrile), 2-(carbamoylazo)isobutyronitrile, 2-phenylazo-4-methoxy-2,4-dimethyl-valeronitrile, 2,2-azobis(2-methyl-N-phenylpropionamidine) dihydrochloride, 2,2′-azobis[N-(4-chlorophenyl)-2-methylpropionamidine]dihydrochloride, 2,2′-azobis[N-hydroxyphenyl]-2-methylpropionamidine]dihydrochloride, 2,2′-azobis[2-methyl-N-(phenylmethyl)propionamidine]dihydrochloride, 2,2′-azobis[2-methyl-N-(2-propenyl)propionamidine]dihydrochloride, 2,2′-azobis(2-methylpropionamidine) dihydrochloride, 2,2′-azobis[N-(2-hydroxyethyl)-2-methylpropionamidine]dihydrochloride, 2,2′-azobis[2-(5-methyl-2-imidazolin-2-yl)propane]dihydrochloride, 2,2′-azobis[2-(2-imidazolin-2-yl)propane]dihydrochloride, 2,2′-azobis[2-(4,5,6,7-tetrahydro-1H-1,3-diazepin-2-yl) propane]dihydrochloride, 2,2′-azobis[2-(3,4,5,6-tetrahydropyrimidin-2-yl)propane]dihydrochloride, 2,2′-azobis[2-(5-hydroxy-3,4,5,6-tetrahydropyrimidin-2-yl) propane]dihydrochloride, 2,2′-azobis{2-[1-(2-hydroxyethyl)-2-imidazolin-2-yl]propane}dihydrochloride, 2,2′-azobis[2-(2-imidazolin-2-yl)propane], 2,2′-azobis{2-methyl-N-[1,1-bis(hydroxymethyl)-2-hydroxyethyl]propionamide}, 2,2′-azobis{2-methyl-N-[1,1-bis(hydroxymethyl)ethyl]propionamide}, 2,2′-azobis[2-methyl-N-(2-hydroxyethyl)propionamide], 2,2′-azobis(2-methylpropionamide)dihydrate, 2,2′-azobis(2,4,4-trimethylpentane), 2,2′-azobis(2-methylpropane), dimethyl 2,2′-azobisisobutyrate, 4,4′-azobis(4-cyanovaleric acid), and 2,2′-azobis[2-(hydroxymethyl)propionitrile].

In the above Chemical Formulae (3), (5) and (6), Y is a halogen-containing functional group. Specifically, the halogen is F, Cl, Br or I, and is preferably Cl or Br. The selection of Cl or Br allows the cathode which may become thermally unstable upon the overcharge to have improved thermal stability. The halogen may be included by replacing at least one hydrogen of an aliphatic hydrocarbon group, an alicyclic hydrocarbon group or an aromatic hydrocarbon group.

In the above Chemical Formulae (4), (5) and (6), W is a highly polar functional group. Examples of the highly polar functional group include oxyalkylene groups [(AO)ₘR], cyano group, amino group, hydroxyl group and thiol group. The application of the highly polar functional group allows the polymer to have higher affinity for the electrolytic solution. In the oxyalkylene groups, AO is ethylene oxide; and R is methyl is preferred. The repetition number “m” is typically from 1 to 20, preferably from 1 to 10, and particularly preferably from 1 to 5.

In the above Chemical Formulae (5), (6) and (7), “a”, “b” and “c” independently represent ratios on molar basis. These ratios may be indicated in percentages (in percent by mole) and, in this case, “a”, “b” and “c” satisfy the following conditions: 0<a≦100, 0<b<100 and 0≦c<100. For obtaining advantageous effects of the present invention, the ratios “a”, “b” and “c” are important. If the ratio “c” is excessively small, the concentration of halogen may become relatively low, and this may reduce the advantageous effects of the present invention. If the ratio “a” is excessively large, the polymer may have low polarity and may thereby become insoluble in the electrolytic solution, and this may lower the advantageous effects of the present invention.

From these viewpoints, the ratio “a” is preferably from 5% to 50%, and particularly preferably from 10% to 40%; and the ratio “c” is preferably from 3% to 70%, and particularly preferably from 5% to 50%.

The polymerizable compounds and the polymer may be present in the lithium secondary battery in any form but are preferably present in coexistence with the electrolytic solution.

The polymerizable compounds and/or the polymer may be present in the electrolytic solution while being dissolved in the electrolytic solution (to form a solution) or while being suspended in the electrolytic solution (to form a suspension).

The concentration (in percent by weight) of the polymerizable compounds and/or polymer may be calculated according to the following Computational Expression (1):

Concentration=(Weight of polymerizable compounds and/or polymer)/[(Weight of electrolytic solution)+(Weight of polymerizable compounds and/or polymer)]×100 Computational Expression (1)

The concentration ranges from 0 to 100 percent by weight, is preferably from 0.01 to 10 percent by weight, and particularly preferably from 1 to 5 percent by weight. With an increasing concentration, the electrolytic solution has decreasing ionic conductivity, and this may adversely affect the battery performance. In contrast, with a decreasing concentration, advantageous effects of the present invention may become insufficient.

The polymer has a number-average molecular weight (Mn) of typically 50000000 or less, preferably 1000000 or less, and more preferably 100000 or less. Such a polymer having a low number-average molecular weight may protect the battery performance from decreasing.

The electrolytic solution contains a nonaqueous solvent and a supporting electrolyte dissolved therein.

The nonaqueous solvent is not limited, as long as being capable of dissolving the supporting electrolyte therein. Among such nonaqueous solvents, preferred are organic solvents such as diethyl carbonate, dimethyl carbonate, ethylene carbonate, ethyl methyl carbonate, propylene carbonate, γ-butyrolactone, tetrahydrofuran and dimethoxyethane. Each of these may be used alone or in combination. Vinylene carbonate or vinyl ethylene carbonate each having an unsaturated double bond in the molecule is also usable herein.

The supporting electrolyte is not limited, as long as being soluble in the nonaqueous solvent, but preferred examples thereof include electrolytic salts such as LiPF₆, LiN(CF₃SO₂)₂, LiN(C₂F₆SO₂)₂, LiClO₄, LiBF₄, LiAsF₆, LiI, LiBr, LiSCN, Li₂B₁₀Cl₁₀ and LiCF₃CO₂. Each of these may be used alone or in combination.

The cathode active material (cathode material) is a material that can occlude and release lithium ions and is represented by the following general formula: LiMO₂ wherein M is a transition metal. Examples of such cathode active materials include oxides having a layered structure, such as LiCoO₂, LiNiO₂, LiMn_{1/3}Ni_{1/3}CO_{1/3}O₂ and LiMn_{0.4}Ni_{0.4}CO_{0.2}O₂, and oxides corresponding to them, except for replacing part of M with at least one metal element selected from the group consisting of Al, Mg, Mn, Fe, Co, Cu, Zn, Ti, Ge, W and Zr. The examples further include manganese (Mn) oxides having a spinel crystal structure, such as LiMn₂O₄ and Li₁₊ₓMn₂₋ₓO₄; and LiFePO₄ and LiMnPO₄ having an olivine structure.

Exemplary materials as the anode material include materials obtained by thermally treating graphitizable materials at a high temperature of 2500° C. or higher, the graphitizable materials being derived typically from naturally-occurring graphite, petroleum coke or coal pitch coke; mesophase carbon; amorphous carbon; carbon fibers; metals that are alloyed with lithium; and materials supporting a metal on a surface of carbon particles. The metal herein may be a metal selected from the group consisting of lithium, silver, aluminum, tin, silicon, indium, gallium and magnesium; or an alloy thereof. Each of the metals and oxides of the metals may be used as the anode. Further, lithium titanate is also usable herein.

Examples of the separator usable herein include those made from polymers such as polyolefins, polyamides and polyesters; and glass cloths using fibrous glass fibers. The material of the separator is not limited, as long as being a reinforcing material that does not adversely affect the lithium battery. But the material of the separator is preferably a polyolefin.

Exemplary polyolefins include polyethylenes and polypropylenes. The separator may be a laminate prepared by laminating films of them.

The separator has a gas permeability (sec/100 mL) of typically from 10 to 1000, preferably from 50 to 800, and particularly preferably from 90 to 700.

The overcharge inhibitor reacts at a predetermined voltage to suppress overcharge. The reaction voltage thereof is a voltage of equal to or higher than the operating voltage of the battery. Specifically, the reaction voltage is typically 2 V or higher, and preferably 4.4 V or higher with respect to Li/Li⁺. The overcharge inhibitor may decompose in the battery to thereby deteriorate the battery performance, if having an excessively low reaction voltage.

The present invention will be illustrated in further detail with reference to several working examples and exemplary embodiments below. However, it should be noted that these are never construed to limit the scope of the present invention.

<Preparation of Electrodes>

<Cathode>

A slurry solution was prepared by mixing Cellseed (lithium cobaltate, supplied by Nippon Chemical Industrial Co., Ltd.), SP270 (graphite, Nippon Graphite Industries, Ltd.), and KF1120 (poly(vinylidene fluoride), supplied by Kureha Corporation) in weight ratio of 85:10:10, and pouring them into N-methyl-2-pyrrolidone, followed by further mixing. The slurry was applied to a 20-μm-thick aluminum foil (a current collector) by a doctor blade method, followed by drying. The mass of coating of the dried mixture was 100 g/m². The resulting electrode was then pressed, cut to a size of 10 cm², and thereby yielded a cathode.

<Anode>

A slurry solution was prepared by mixing a synthetic graphite and a poly (vinylidene fluoride) in a weight ratio of 90:10, and pouring them into N-methyl-2-pyrrolidone, followed by mixing. The slurry was applied to a 20-μm-thick copper foil (a current collector) by the doctor blade method, followed by drying. The mass of coating of the dried mixture was 40 g/m². The resulting electrode was pressed to a bulk density of the dried mixture of 1.0 g/cm³, cut to a size of 10 cm², and thereby yielded an anode.

<Preparation and Evaluation of Laminated Battery>

An electrode group was formed by interposing a polyolefin separator in between the cathode and the anode. An electrolytic solution was poured into the electrode group. The resulting electrode group was sealed with an aluminum lamination material and thereby yielded a battery. The battery was thereafter initialized by repeating charging and discharging cycles a total of three times.

The charging of battery was performed to a predetermined upper limit voltage at a current density of 0.1 mA/cm². The discharging of battery was performed to a predetermined lower limit voltage at a current density of 0.1 mA/cm². The upper limit voltage was 4.2 V, whereas the lower limit voltage was 2.5 V. A discharge capacity obtained in the third cycle was defined as a battery capacity. The prepared battery was then overcharged to 5.0 V at a current density of 0.1 mA/cm².

<Thermal Stability Test>

The overcharged battery was disassembled, and the cathode and the anode were separated from each other. The separated cathode or anode was placed in a measurement cell, into which an electrolytic solution was poured. The measurement cell was then placed in a differential scanning calorimeter (DSC). The resulting measurement sample was heated at a rate of temperature rise of 1° C./min. The measurement temperature ranged from 25° C. to 300° C.

### Example 1

There was prepared a mixture of Monomer (1) (0.2 mol, 46 g) represented by the following Chemical Formula (8), Monomer (2) (0.6 mol, 113 g) represented by the following Chemical Formula (9) and Monomer (3) (0.2 mol, 36.4 g) represented by the following Chemical Formula (10):

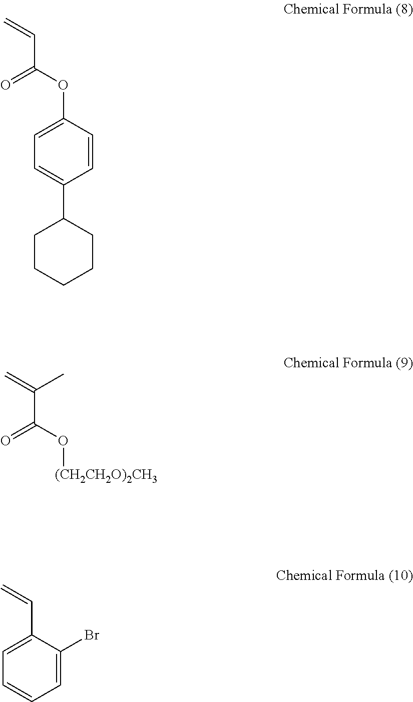

The mixture was combined with azobisisobutyronitrile (AIBN) serving as a polymerization initiator in an amount of 1 part by weight per 100 parts by weight of the total amount of Monomer (1), Monomer (2) and Monomer (3), followed by stirring until AIBN was dissolved. Next, the reaction solution was sealed and reacted on an oil bath at 60° C. for 3 hours. After the completion of reaction, the reaction solution was added to 200 mL of methanol to give white precipitates. The precipitates were collected from the mixture by filtration, dried at 60° C. under a reduced pressure, and thereby yielded Polymer A.

Polymer A was added to a concentration of 3 percent by weight to an electrolytic solution (electrolytic salt: LiPF₆, solvent: EC/DMC/EMC=1:1:1 (by volume), electrolytic salt concentration: 1 mol/L). Herein, “EC” is ethylene carbonate, DMC is dimethyl carbonate, and EMC is ethyl methyl carbonate.

Using this electrolytic solution, a battery was prepared, and properties thereof were evaluated.

The prepared battery was found to have a battery capacity of 80 mAh.

Next, the battery was overcharged, and disassembled, and the cathode and the anode were separated from each other. The separated cathode and anode were respectively placed in the DSC measurement cells. The electrolytic solution was added to the cells, and the cells were sealed. The sealed cells were respectively placed in the differential scanning calorimeter, and the thermal stability was measured.

As a result, the cathode was found to have an exothermic onset temperature of 261° C., and the anode was found to have an exothermic onset temperature of 185° C.

### Example 2

There was prepared a mixture of Monomer (1) (0.2 mol, 46 g), Monomer (2) (0.6 mol, 113 g) and Monomer (4) (0.2 mol, 52 g) represented by the following Chemical Formula (11):

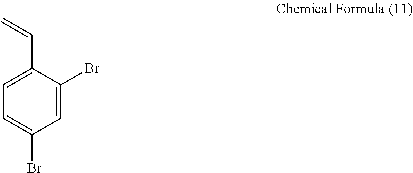

The mixture was combined with azobisisobutyronitrile (AIBN) serving as a polymerization initiator in an amount of 1 part by weight per 100 parts by weight of the total amount of Monomer (1), Monomer (2) and Monomer (4), followed by stirring until AIBN was dissolved. Next, the reaction solution was sealed and reacted on an oil bath at 60° C. for 3 hours. After the completion of reaction, the reaction solution was added to 200 mL of methanol to give white precipitates. The precipitates were collected from the mixture by filtration, dried at 60° C. under a reduced pressure, and thereby yielded Polymer B.

Polymer B was added to a concentration of 3 percent by weight to an electrolytic solution (electrolytic salt: LiPF₆, solvent: EC/DMC/EMC=1:1:1 (by volume), electrolytic salt concentration: 1 mol/L).

Using this electrolytic solution, a battery was prepared, and properties thereof were evaluated.

The prepared battery was found to have a battery capacity of 80 mAh.

Next, the battery was overcharged, and thereafter disassembled, and the cathode and the anode were separated from each other. The separated cathode and anode were respectively placed in the DSC measurement cells. The electrolytic solution was added to the cells, and the cells were sealed. The sealed cells were respectively placed in the differential scanning calorimeter, and the thermal stability was measured.

As a result, the cathode was found to have an exothermic onset temperature of 268° C., and the anode was found to have an exothermic onset temperature of 186° C.

### Example 3

There was prepared a mixture of Monomer (1) (0.2 mol, 46 g), Monomer (2) (0.6 mol, 113 g) and Monomer (5) (0.2 mol, 28 g) represented by the following Chemical Formula (12):

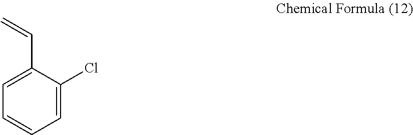

The mixture was combined with azobisisobutyronitrile (AIBN) serving as a polymerization initiator in an amount of 1 part by weight per 100 parts by weight of the total amount of Monomer (1), Monomer (2) and Monomer (5), followed by stirring until AIBN was dissolved. Next, the reaction solution was sealed and reacted on an oil bath at 60° C. for 3 hours. After the completion of reaction, the reaction solution was added to 200 mL of methanol to give white precipitates. The precipitates were collected from the mixture by filtration, dried at 60° C. under a reduced pressure, and thereby yielded Polymer C.

Polymer C was added to a concentration of 3 percent by weight to an electrolytic solution (electrolytic salt: LiPF₆, solvent: EC/DMC/EMC=1:1:1 (by volume), electrolytic salt concentration: 1 mol/L).

Using this electrolytic solution, a battery was prepared, and properties thereof were evaluated.

The prepared battery was found to have a battery capacity of 80 mAh.

Next, the battery was overcharged, and thereafter disassembled, and the cathode and the anode were separated from each other. The separated cathode and anode were respectively placed in the DSC measurement cells. The electrolytic solution was added to the cells, and the cells were sealed. The sealed cells were respectively placed in the differential scanning calorimeter, and the thermal stability was measured.

As a result, the cathode was found to have an exothermic onset temperature of 271° C., and the anode was found to have an exothermic onset temperature of 184° C.

### Example 4

There was prepared a mixture of Monomer (1) (0.2 mol, 46 g), Monomer (2) (0.6 mol, 113 g) and Monomer (6) (0.2 mol, 35 g) represented by the following Chemical Formula (13):

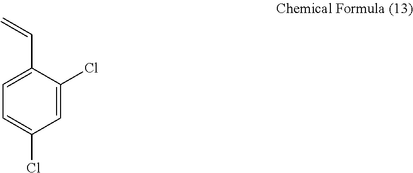

The mixture was combined with azobisisobutyronitrile (AIBN) serving as a polymerization initiator in an amount of 1 part by weight per 100 parts by weight of the total amount of Monomer (1), Monomer (2) and Monomer (6), followed by stirring until AIBN was dissolved. Next, the reaction solution was sealed and reacted on an oil bath at 60° C. for 3 hours. After the completion of reaction, the reaction solution was added to 200 mL of methanol to give white precipitates. The precipitates were collected from the mixture by filtration, dried at 60° C. under a reduced pressure, and thereby yielded Polymer D.

Polymer D was added to a concentration of 3 percent by weight to an electrolytic solution (electrolytic salt: LiPF₆, solvent: EC/DMC/EMC=1:1:1 (by volume), electrolytic salt concentration: 1 mol/L).

Using this electrolytic solution, a battery was prepared, and properties thereof were evaluated.

The prepared battery was found to have a battery capacity of 80 mAh.

Next, the battery was overcharged, and thereafter disassembled, and the cathode and the anode were separated from each other. The separated cathode and anode were respectively placed in the DSC measurement cells. The electrolytic solution was added to the cells, and the cells were sealed. The sealed cells were respectively placed in the differential scanning calorimeter, and the thermal stability was measured.

The cathode was found to have an exothermic onset temperature of 274° C., and the anode was found to have an exothermic onset temperature of 184° C.

### Example 5

A battery was prepared, and the thermal stability thereof was evaluated by the procedure of Example 4, except for using Polymer D in a concentration of 11 percent by weight.

The prepared battery was found to have a battery capacity of 76 mAh. The cathode was found to have an exothermic onset temperature of 263° C., and the anode was found to have an exothermic onset temperature of 179° C.

### Example 6

In a glass ampule, Monomer (1) (0.2 mol, 46 g) and Monomer (2) (0.6 mol, 113 g) were mixed. The mixture was combined with V70 supplied by Wako Pure Chemical Industries, Ltd. (2,2′-azobis(4-methoxy-2,4-dimethylvaleronitrile)) serving as a polymerization initiator.

The resulting solution was cooled with dry ice. Independently, cooled vinyl chloride in the form of liquid (Monomer (7) represented by the following Chemical Formula (14)) (0.2 mol, 12.6 g) was added to a glass ampule, and the ampule was sealed.

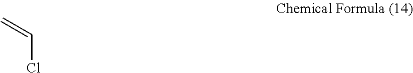

The ampule was heated. After the completion of reaction, the reaction solution was added to 200 mL of methanol to give white precipitates. The precipitates were collected from the mixture by filtration, dried at 60° C. under a reduced pressure, and thereby yielded Polymer E.

Polymer E was added to a concentration of 3 percent by weight to an electrolytic solution (electrolytic salt: solvent: EC/DMC/EMC=1:1:1 (by volume), electrolytic salt concentration: 1 mol/L).

Using this electrolytic solution, a battery was prepared, and properties thereof were evaluated.

The prepared battery was found to have a battery capacity of 81 mAh.

Next, the battery was overcharged, and thereafter disassembled, and the cathode and the anode were separated from each other. The separated cathode and anode were respectively placed in the DSC measurement cells. The electrolytic solution was added to the cells, and the cells were sealed. The sealed cells were respectively placed in the differential scanning calorimeter, and the thermal stability was measured.

The cathode was found to have an exothermic onset temperature of 265° C., and the anode was found to have an exothermic onset temperature of 180° C.

### Example 7

There was prepared a mixture of Monomer (1) (0.2 mol, 46 g), Monomer (2) (0.6 mol, 113 g) and Monomer (8) (0.2 mol, 75.8 g) represented by the following Chemical Formula (15):

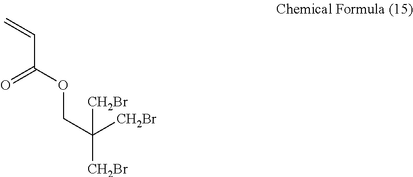

The mixture was combined with azobisisobutyronitrile (AIBN) serving as a polymerization initiator in an amount of 1 part by weight per 100 parts by weight of the total amount of Monomer (1), Monomer (2) and Monomer (8), followed by stirring until AIBN was dissolved. Next, the reaction solution was sealed and reacted on an oil bath at 60° C. for 3 hours. After the completion of reaction, the reaction solution was added to 200 mL of methanol to give white precipitates. The precipitates were collected from the mixture by filtration, dried at 60° C. under a reduced pressure, and thereby yielded Polymer F.

Polymer F was added to a concentration of 3 percent by weight to an electrolytic solution (electrolytic salt: LiPF₆, solvent: EC/DMC/EMC=1:1:1 (by volume), electrolytic salt concentration: 1 mol/L).

Using this electrolytic solution, a battery was prepared, and properties thereof were evaluated.

The prepared battery was found to have a battery capacity of 80 mAh.

Next, the battery was overcharged, and thereafter disassembled, and the cathode and the anode were separated from each other. The separated cathode and anode were respectively placed in the DSC measurement cells. The electrolytic solution was added to the cells, and the cells were sealed. The sealed cells were respectively placed in the differential scanning calorimeter, and the thermal stability was measured.

The cathode was found to have an exothermic onset temperature of 272° C., and the anode was found to have an exothermic onset temperature of 181° C.

### Comparative Example 1

A battery was prepared, and properties thereof were evaluated by the procedure of Example 1, except for not using a polymer.

The battery was found to have a battery capacity of 80 mAh. The cathode was found to have an exothermic onset temperature of 230° C., and the anode was found to have an exothermic onset temperature of 180° C.

### Comparative Example 2

A battery was prepared, and properties thereof were evaluated by the procedure of Example 1, except for using bromobenzene instead of the polymer. The battery was found to have a battery capacity of 70 mAh. The cathode was found to have an exothermic onset temperature of 235° C., and the anode was found to have an exothermic onset temperature of 171° C.

### Comparative Example 3

A battery was prepared, and properties thereof were by the procedure of Example 1, except for using chlorobenzene instead of the polymer.

The battery was found to have a battery capacity of 68 mAh. The cathode was found to have an exothermic onset temperature of 237° C., and the anode was found to have an exothermic onset temperature of 169° C.

Table 1 indicates the results of the examples and comparative examples collectively.

TABLE 1

| | | | | | | | | | | Cathode | Anode |
|---|---|---|---|---|---|---|---|---|---|---|---|
| | | | | Copolymer- | | | | | | exothermic | exothermic |
| | | | | ization | | | Concentration | | Battery | onset | onset |
| | Monomers | | | composition | | | (percent by | Polymer | capacity | temperature | temperature |
| | a | b | c | a | b | c | weight) | name | (mAh) | (° C.) | (° C.) |
| Example 1 | Monomer (1) | Monomer (2) | Monomer (3) | 20 | 60 | 20 | 3 | Polymer A | 80 | 261 | 185 |
| Example 2 | Monomer (1) | Monomer (2) | Monomer (4) | 20 | 60 | 20 | 3 | Polymer B | 80 | 268 | 186 |
| Example 3 | Monomer (1) | Monomer (2) | Monomer (5) | 20 | 60 | 20 | 3 | Polymer C | 81 | 271 | 184 |
| Example 4 | Monomer (1) | Monomer (2) | Monomer (6) | 20 | 60 | 20 | 3 | Polymer D | 80 | 274 | 184 |
| Example 5 | Monomer (1) | Monomer (2) | Monomer (6) | 20 | 60 | 20 | 11 | Polymer D | 76 | 263 | 179 |
| Example 6 | Monomer (1) | Monomer (2) | Monomer (7) | 20 | 60 | 20 | 3 | Polymer E | 81 | 265 | 180 |
| Example 7 | Monomer (1) | Monomer (2) | Monomer (8) | 20 | 60 | 20 | 3 | Polymer F | 80 | 272 | 181 |

| | | | | | | |
|---|---|---|---|---|---|---|
| Com. Ex. 1 | — | — | — | 80 | 230 | 180 |
| Com. Ex. 2 | Bromobenzene | 3 | — | 70 | 235 | 171 |
| Com. Ex. 3 | Chlorobenzene | 3 | — | 68 | 237 | 169 |

Table 1 demonstrates that the batteries according to Examples 1 to 7 had cathode exothermic onset temperatures of from 261° C. to 274° C. higher than those of the batteries according to Comparative Examples 1 to 3.

The structures of lithium secondary batteries according to some embodiments will be illustrated with reference to the attached drawings.

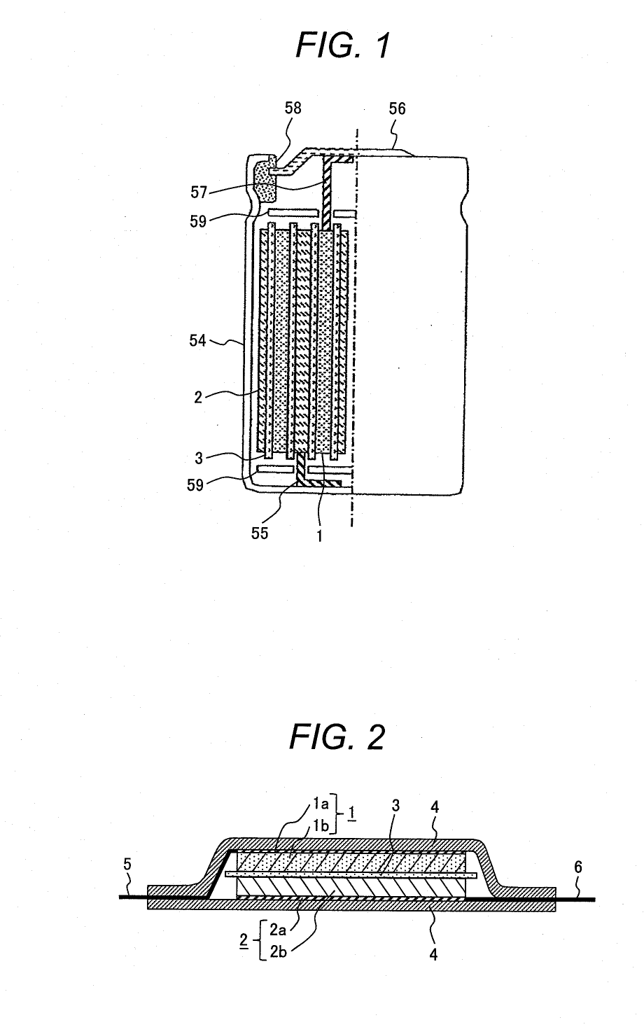

FIG. 1 is a local sectional view illustrating a lithium secondary battery (a cylindrical lithium-ion battery).

A cathode 1 and an anode 2 are cylindrically wound with the interposition of a separator 3 so as to avoid direct contact between the two electrodes and thereby form an electrode group. A cathode lead 57 is annexed to the cathode 1, and an anode lead 55 is annexed to the anode 2.

The electrode group is placed in a battery can 54. Insulating plates 59 are installed in the bottom and top portions of the battery can 54 so as to avoid direct contact of the electrode group with the battery can 54. The battery can 54 contains an electrolytic solution inside thereof.

The battery can 54 and a cap 56 are sealed via a gasket 58 while being insulated from each other.

FIG. 2 is a cross-sectional view illustrating a secondary battery (a laminated cell) according to another embodiment.

The secondary battery illustrated in FIG. 2 structurally includes a package 4 in which an assembly is composed of a cathode 1 and an anode 2 and a separator 3 interposed therebetween with a nonaqueous electrolytic solution. The cathode 1 includes a cathode current collector 1a and a cathode mixture layer 1b, whereas the anode 2 includes an anode current collector 2a and an anode mixture layer 2b. The cathode current collector 1a is connected to a cathode terminal 5, whereas the anode current collector 2a is connected to an anode terminal 6.

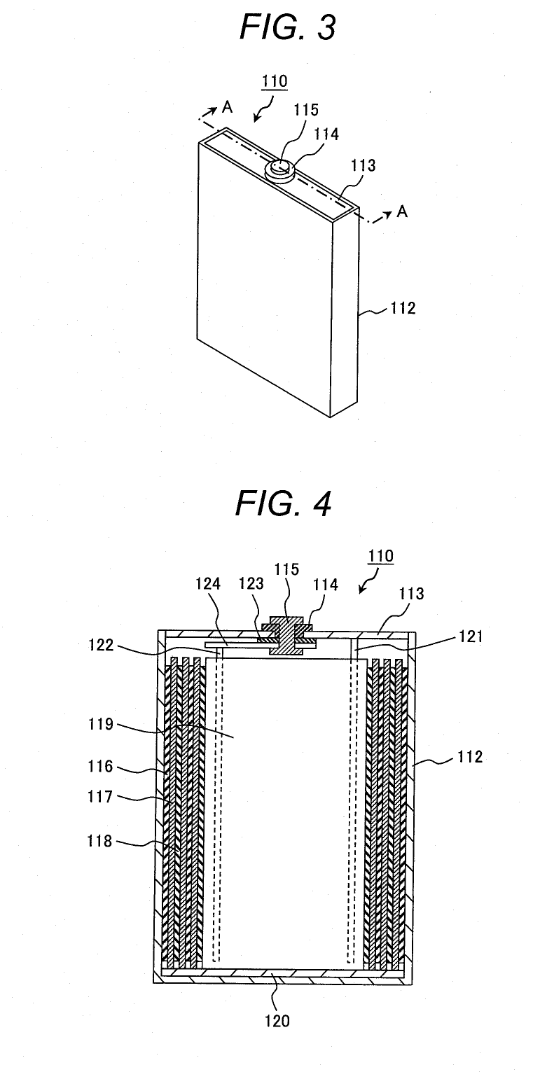

FIG. 3 is a perspective view illustrating a secondary battery (a rectangular battery) according to still another embodiment.

With reference to FIG. 3, a battery 110 (a nonaqueous electrolyte secondary battery) includes an oblately wound electrode assembly together with a nonaqueous electrolytic solution in a rectangular outer can 112. A terminal 115 is provided via an insulator 114 in a central portion of a lid plate 113.

FIG. 4 is a cross-sectional view taken along line A-A in FIG. 3.

With reference to FIG. 4, a cathode 116 and an anode 118 are wound with the interposition of a separator 117 to form an oblately wound electrode assembly 119. At the bottom of the outer can 112, an insulator 120 is provided so as to avoid shortings between the cathode 116 and the anode 118.

The cathode 116 is connected via a cathode lead 121 to a lid plate 113; whereas the anode 118 is connected to a terminal 115 via an anode lead 122 and an anode lead plate 124. An insulator 123 is arranged between the lead plate 124 and the lid plate 113 so as to avoid a direct contact between them.

It should be noted that the secondary batteries according to the above embodiments are indicated only by way of example, and that the secondary batteries according to the present invention are not limited thereto and include all secondary batteries to which the overcharge inhibitor is adopted.

What is claimed is:

1. An overcharge inhibitor for a lithium secondary battery comprising polymerizable compounds or a polymer, or both as an active component,
the polymerizable compounds including:
a first polymerizable compound having an aromatic functional group and a polymerizable functional group, and
a second polymerizable compound having a halogen-containing functional group and a polymerizable functional group, and
the polymer including a polymer having:
the halogen-containing functional group,
the aromatic functional group, and
residues of the polymerizable functional groups.

2. The overcharge inhibitor according to claim 1,
wherein the polymerizable compounds further include a third polymerizable compound having a highly polar functional group and a polymerizable functional group, and
wherein the polymer further has the highly polar functional group.

3. The overcharge inhibitor according to claim 1,
wherein the aromatic functional group has the halogen-containing functional group.

4. The overcharge inhibitor according to claim 1,
wherein the polymerizable compounds include the first polymerizable compound represented by the following Chemical Formula (1) or (2); and the second and third polymerizable compounds respectively represented by the following Chemical Formulae (3) and (4):
Z¹—X-A Chemical Formula (1)
Z¹-A Chemical Formula (2)
Z²—Y Chemical Formula (3)
Z³—W Chemical Formula (4)
wherein Z¹, Z² and Z³ are respectively polymerizable functional groups; X is a hydrocarbon group or an oxyalkylene group having 1 to 20 carbon atoms; A is an aromatic functional group; Y is a halogen-containing functional group; and W is a highly polar functional group.

5. The overcharge inhibitor according to claim 4, including a polymer obtained from the polymerizable compounds through polymerization.

6. The overcharge inhibitor according to claim 1,
wherein the polymer includes a polymer represented by the following Chemical Formula (5) or (6): 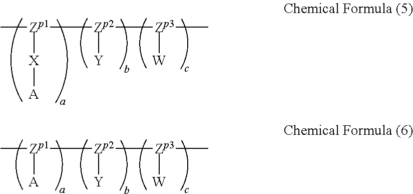
wherein Z^{p1}, Z^{p2} and Z^{p3} are respectively residues of polymerizable functional groups; X is a hydrocarbon group or an oxyalkylene group having 1 to 20 carbon atoms; A is an aromatic functional group; Y is a halogen-containing functional group; W is a highly polar functional group; and “a”, “b” and “c” independently represent ratios on molar basis.

7. The overcharge inhibitor according to claim 6,
wherein the polymer is represented by the following Chemical Formula (7): 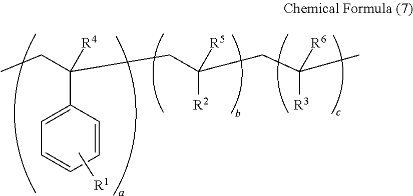
wherein R¹ is one selected from the group consisting of hydrogen atom, an aliphatic hydrocarbon group, an alicyclic hydrocarbon group and an aromatic group; R² is a halogen-containing functional group; R³ is a functional group having one selected from the group consisting of an oxyalkylene group, cyano group, amino group and hydroxyl group; R⁴, R⁵ and R⁶ are each independently hydrogen atom or a hydrocarbon group; and “a”, “b” and “c” independently represent ratios on molar basis.

8. The overcharge inhibitor according to claim 1,
wherein the halogen is at least one selected from bromine and chlorine.

9. An electrolytic solution for a lithium secondary battery, including the overcharge inhibitor according to claim 1.

10. A lithium secondary battery including the overcharge inhibitor according to claim 1.

11. A method for producing a polymer, the method comprising the steps of:
preparing a mixture including a first polymerizable compound and a second polymerizable compound, the first polymerizable compound having an aromatic functional group and a polymerizable functional group, and the second polymerizable compound having a halogen-containing functional group and a polymerizable functional group; and
polymerizing the first and second polymerizable compounds.

12. The method according to claim 11,
wherein the mixture further includes a third polymerizable compound having a highly polar functional group and a polymerizable functional group.

13. The method according to claim 11,
wherein the aromatic functional group has the halogen-containing functional group.

14. The method according to claim 11,
wherein the mixture includes a first polymerizable compound represented by the following Chemical Formula (1) or (2); and second and third polymerizable compounds respectively represented by the following Chemical Formulae (3) and (4):
Z¹—X-A Chemical Formula (1)
Z¹-A Chemical Formula (2)
Z²—Y Chemical Formula (3)
Z³—W Chemical Formula (4)
wherein Z¹, Z² and Z³ are respectively polymerizable functional groups; X is a hydrocarbon group or an oxyalkylene group having 1 to 20 carbon atoms; A is an aromatic functional group; Y is a halogen-containing functional group; and W is a highly polar functional group.

15. The method according to claim 11,
further comprising a step of adding a polymerization initiator to the mixture to perform a reaction.

16. The method according to claim 11,
wherein the halogen is at least one of bromine and chlorine.
